(19) United States
(12) Patent Application Publication
(10) Pub. No.: US 2007/0261081 A1
(43) Pub. Date: Nov. 8, 2007

(54) DVB-H DATA PROVISION

(75) Inventors: Per Anders NILSSON, Lund (SE); Magnus JENDBRO, Staffanstorp (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/530,266

(22) Filed: Sep. 8, 2006

Related U.S. Application Data
(60) Provisional application No. 60/745,318, filed on Apr. 21, 2006.

(51) Int. Cl. H04N 7/16; H04N 7/18

(52) U.S. Cl. 725/62; 725/81; 725/78

(57) ABSTRACT

A method for providing a first media data by a first portable electronic communication device is provided. The method includes receiving a request from a second portable communication device to send first media data to the second portable communication device receiving the first media data in the form of bursts using a first communication technology, sending the first media data to at least the second portable communication device using a second communication technology, the second communication technology being different than the first communication technology, such that the second portable communication device can receive the first media data using the second communication technology.

### RELATED APPLICATION

This application claims priority under 35 U.S.C. § 119 based on U.S. Provisional Application Ser. No. 60/745,318, filed Apr. 21, 2006, the disclosure of which is incorporated herein by reference.

### FIELD OF THE INVENTION

Embodiments of the invention relate in general to provision of media data, and in particular to a method of and a portable electronic communication device for providing media data, as well as a computer program product and a computer program element for carrying computer readable code means for executing corresponding steps.

### BACKGROUND OF THE INVENTION

Hand-held electronic devices (e.g., mobile phones) provide an increasing amount of features related to providing various types of media content. It is now possible for users of hand-held electronic devices to receive media, such as TV broadcasts (e.g., TV programs).

Various segments of mobile phones are available of which some are provided with the functionality to receive TV programs, whereas others do not comprise such functionality, possibly due to price, weight, size and/or design.

One technology to transmit media to an electronic device is to broadcast the media, for instance, as TV programs. Digital video broadcasting (DVB) is one such example of which DVB-handheld (DVB-H) in particular is one way to provide digital media to hand-held electronic devices by broadcasting the digital media to such hand-held electronic devices, of which mobile phones are examples of one type.

One problem connected to digital transmission of data using the DVB-H standard is the relatively long “zapping time,” i.e. the time it takes to switch from one channel or media stream to another channel or media stream. When a user selects a new channel or starts the DVB-H application, it may take a few seconds until data from the chosen new channel can be presented. The main reason for this long duration is that DVB-H data is broadcasted in the form of bursts in intervals having off-times of several seconds in between. This time delay may be annoying to a user who is switching channels or is starting the DVB-H application, that is, to a user initiating presentation of novel DVB-H data.

### SUMMARY OF THE INVENTION

According to a first embodiment, a method of providing a first media data by a first portable electronic communication device is disclosed. The method includes receiving a request from a second portable communication device to send first media data to the second portable communication device, receiving the first media data in the form of bursts using a first communication technology, and sending the first media data to at least the second portable communication device using a second communication technology, the second communication technology being different than the first communication technology, such that the second portable communication device can receive said first media data using the second communication technology.

A second embodiment is directed towards a method including the features of the first embodiment, wherein the first communication technology comprises a digital video broadcasting-handheld (DVB-H) broadcasting communication technology.

A third embodiment is directed towards a method including the features of the first embodiment, further comprising extracting the first media data from at least one of the received bursts.

A fourth embodiment is directed towards a method including the features of the first embodiment, wherein the second communication technology comprises a wired communication technology.

A fifth embodiment is directed towards a method including the features of the first embodiment, wherein the receiving the request comprises receiving the request using a third communication technology.

A sixth embodiment is directed towards a method including the features of the fifth embodiment, wherein the third communication technology comprises the second communication technology.

A seventh embodiment is directed towards a method including the features of the first embodiment, wherein the second communication technology comprises a wireless communication technology.

An eighth embodiment is directed towards a method including the features of the seventh embodiment, wherein the second communication technology comprises Bluetooth technology.

A ninth embodiment is directed towards a method including the features of the seventh embodiment, wherein the second communication technology comprises infra-red communication technology.

A tenth embodiment is directed towards a method including the features of the seventh embodiment, wherein the second communication technology comprises communication over a wireless local area network.

According to an eleventh embodiment, a portable communication device comprises a first receiving unit arranged to receive the first media data in the form of bursts using a first communication technology, a second receiving unit arranged to receive a request from a second portable communication device to send first media data to the second portable communication device, a transmitting unit arranged to send the first media data to at least the second portable communication device using a second communication technology, the second communication technology being different than the first communication technology, and a control unit arranged to control receiving the first media data in the form of bursts using the first communication technology, to control receiving the request from the second portable communication device to send first media data to the second portable communication device, and to control sending the first media data to at least the second portable electronic communication device using the second communication technology, so that first media data is provided to the second portable communication device.

A twelfth embodiment is directed towards a portable electronic communication device including the features of the eleventh embodiment, wherein the first receiving unit comprises a digital video broadcasting-handheld (DVB-H) receiver arranged to receive broadcasted media data.

A thirteenth embodiment is directed towards a portable communication device including the features of the eleventh embodiment, further comprising a data extracting unit arranged to extract the first media data from at least one of the received bursts.

A fourteenth embodiment is directed towards a portable communication device including the features of the eleventh embodiment, wherein the transmitting unit comprises a Bluetooth transmitter, wherein the control unit further is arranged to control sending the first media data to at least the second portable communication device using Bluetooth technology.

A fifteenth embodiment is directed towards a portable communication device including the features of the eleventh embodiment, wherein the second receiving unit comprises a Bluetooth receiver.

A sixteenth embodiment is directed towards a portable communication device including the features of the eleventh embodiment, wherein the portable communication device and the second portable communication device include mobile phones.

According to a seventeenth embodiment, a computer program product comprising a computer readable medium having thereon computer readable code, to make a computer or a portable electronic communication device execute, when the computer readable code is loaded in the computer or the portable electronic communication device, a method comprises receiving a request from a second portable communication device to send first media data to the second portable communication electronic device, receiving the first media data in the form of bursts using a first communication technology, and sending the first media data to at least the second portable electronic communication device using a second communication technology, the second communication technology being different than the first communication technology.

According to an eighteenth embodiment, a computer program element comprising computer readable code to make a computer or a portable electronic communication device execute, when the computer readable code is loaded in the computer or the portable electronic communication device, a method comprises receiving a request from a second portable communication device to send first media data to the second portable communication device, receiving the first media data in the form of bursts using a first communication technology, and sending the first media data to at least the second portable communication device using a second communication technology, the second communication technology being different than the first communication technology.

### BRIEF DESCRIPTION OF THE DRAWINGS

The present invention will now be described in more detail in relation to the enclosed drawings, in which:

FIG. 1 schematically shows a portable electronic communication device according to one embodiment of the invention,

FIG. 2 presents a flow chart of an exemplary method of providing a first media data by a first portable electronic communication device according to one embodiment of the invention,

FIG. 3 presents a flow chart of an exemplary method of providing a first media data by a first portable electronic communication device according to another embodiment of the invention,

FIG. 4 displays an exemplary portable electronic communication device in the form of a mobile phone, according to one embodiment of the invention, and

FIG. 5 illustrates a computer program product, having thereon computer program code means to make a portable electronic communication device or a computer execute steps in line with the methods consistent with principles of the invention.

### DETAILED DESCRIPTION OF THE EMBODIMENTS

Embodiments consistent with principles of the invention distribute digital video data, which is one example of first media data, from a first portable electronic communication device, such as a mobile phone having on-going access to such data, to a second portable electronic communication device that does not have on-going access to the data. The first media data may be received in the form of DVB-H bursts using DVB-H technology, after which the data is extracted from at least one burst and sent to the second portable electronic communication device, such as for instance a mobile phone, using a second communication technology such as Bluetooth technology.

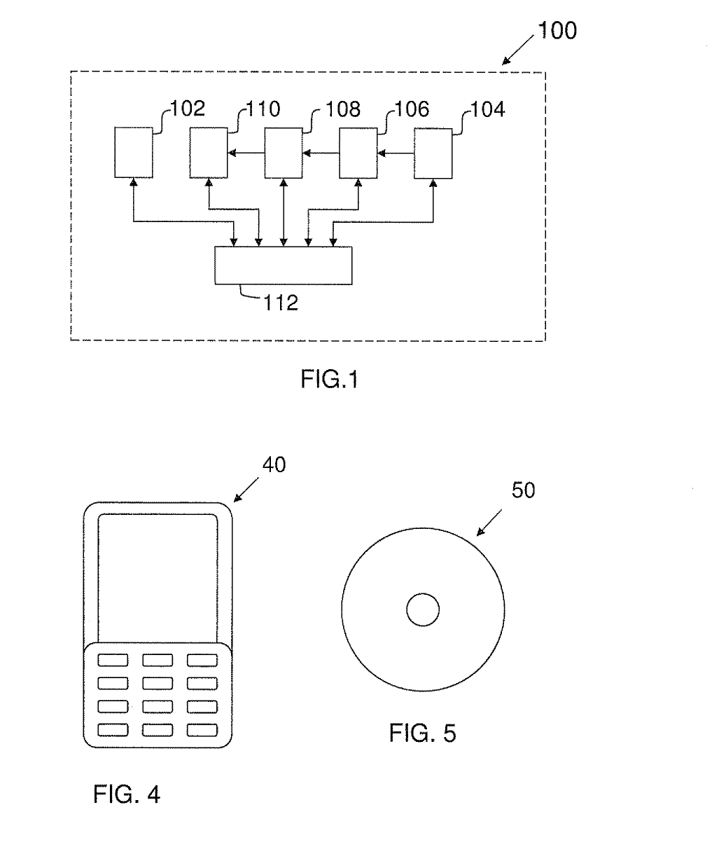

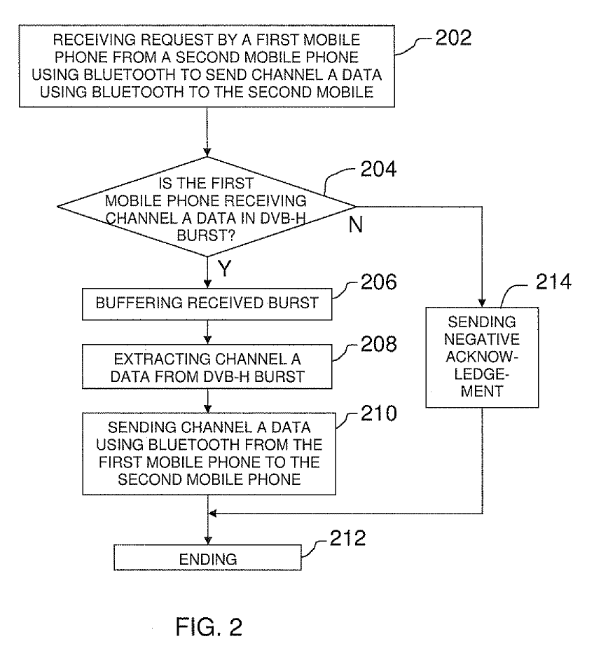

FIG. 1 schematically depicts a portable electronic communication device according to one embodiment of the invention. FIG. 2 presents a flow chart of an exemplary method of providing a first media data, according to one embodiment of the invention, by a first portable electronic communication device 100. With reference to FIGS. 1 and 2, an embodiment consistent with principles of the invention is provided.

According to this embodiment of the invention, the portable communication device 100 comprises a first receiving unit 104, a second receiving unit 102, a memory unit 106, a data extracting unit 108, a transmitting unit 1 10 and a control unit 112. As shown in FIG. 1, and according to this embodiment, the second receiving unit 102 is connected to the control unit 112 only, whereas the first receiving unit 104, the memory unit 106, the data extracting unit 108 and the transmitting unit 110 are connected to each other in sequence, and are each connected to the control unit 112.

The flow-chart of FIG. 2 shows an exemplary method of providing channel A data, as one example of first media data, by a first portable electronic communication device 100, such as a mobile phone, to a second electronic communication device, which also may be exemplified by a mobile phone.

When a user of the second mobile phone changes channels (e.g., from channel B to channel A), channel A data may not be available to the second mobile phone since the receiver of the second mobile phone is switched off between the received channel B bursts. Since channel A bursts are transmitted with a time interval of approximately 3-4 seconds, the waiting time as experienced by the user would be reduced if channel A data could be made available to the second mobile in advance of receiving the channel A burst by the second mobile phone. One way to obtain channel A data is to send a request to another mobile phone currently receiving channel A burst data, to send channel A data to the second mobile phone.

Since any novel channel A data burst can be received by the second mobile phone itself, it is sufficient to provide channel A data corresponding to one DVB-H data burst from the first mobile phone to the second mobile phone, in this embodiment of the invention.

The following embodiment is also applicable to the case in which a user switches on the DVB-H application in order to consume media data. As the application is just switched on, it is very unlikely that data for the selected channel is available immediately, for which reason a request can be sent to another portable electronic communication device to provide the requested media data to the user equipment.

In the following paragraphs, an exemplary method of providing such channel A data by the first mobile phone to the second mobile phone is described.

Processing may begin with a first portable electronic communication device (e.g., a mobile phone) receiving a request from a second portable electronic communication device, such as a mobile phone, using Bluetooth, to send channel A data using Bluetooth to the second mobile (block 202). Bluetooth is solely one example of a communication technology via which media data may be transmitted between portable electronic communication devices.

A variety of other communication technologies may be used, such as other wireless, wired, and/or optical communication technologies. For example, Infra-Red (IR) communication technology, Wireless Local Area Network (W-LAN) technologies or even wired technologies, such as Public Switched Telephone Network (PSTN), may be used.

The request may be received by second receiving unit 102 under the control of the control unit 112. In this embodiment, the second receiving unit 102 may comprise a Bluetooth receiving unit. Having received the request, it may be determined whether the first mobile phone, as one example of a portable electronic communication device, is receiving channel A data in DVB-H bursts, or not (block 204). This determination may be performed by the control unit 112, in dependence of potential input that may be received by the first receiving unit 104. In this embodiment, the first receiving unit 104 may comprise a DVB-H receiving unit. If the control unit 112 determines that the first mobile phone is receiving channel A data in DVB-H bursts, the received channel A burst data may be buffered in the memory unit 106 (block 206). After having buffered the burst data comprising channel A data in the memory unit 106, channel A data may be extracted from the DVB-H burst data (block 208). The extraction may be performed by the data extracting unit 108 under the control of the control unit 112.

According to one embodiment consistent with principles of the invention, after having determined that the portable electronic communication device is receiving channel A data in DVB-H bursts, or not (block 204), it is determined whether or not there is available a buffered data burst in the memory unit 106. If a burst is already available, the channel A data comprised therein may be sent to the second portable electronic communication device. Therefore, there is no need to await an incoming burst. Since channel A data is being received by the first portable electronic communication device, burst data is typically already available to be consumed.

By extracting the channel A data from the DVB-H burst data, channel A data may be accessed in the form of Internet Protocol (IP) datagrams. These IP datagrams may be sent from the first mobile phone to the second mobile phone (block 210). In one embodiment, the first mobile phone sends the IP datagrams using the Bluetooth protocol. The transmitting unit 110 may transmit the IP datagrams, having access to the extracted channel A data, for instance in the form of IP datagrams, from the extracting unit 108, under control of the control unit 112.

As mentioned above, in this embodiment, the first mobile phone sends channel A data of an amount corresponding to one channel A DVB-H data burst. There is thus no need to send larger amounts of channel A data or data corresponding to a second DVB-H data burst from the first mobile phone to the second mobile phone. As such, second DVB-H data burst information will be available to the second phone at the same time as it is available to the first mobile phone.

The second mobile phone can thus make use of received channel A data and, for instance, present such data during the time that it lasts when being consumed (e.g., until the time at which the second mobile phone itself receives the second or novel DVB-H data burst).

Returning to the method for which the flow-chart is presented in FIG. 2 and to block 204 in which it is determined whether or not the first mobile phone is receiving channel A data in DVB-H bursts, it may be determined that the first mobile phone is not receiving channel A DVB-H data bursts. In such a case, the first mobile phone may send a negative acknowledgement to the second mobile phone (block 214). Within this embodiment, the acknowledgement may be sent using the same communication technology as was used for receiving the request in block 202, that is Bluetooth technology. According to an alternative embodiment of the invention, a different second communication technology may be used in block 214.

After having sent channel A data, using, for instance, Bluetooth, from the first mobile phone to the second mobile phone or alternatively after having sent the negative acknowledgement in block 214, the method may end in block 212.

According to another embodiment of the invention, a method may provide DVB-H channel data by a portable electronic communication device being arranged to receive DVB-H data bursts to at least one other portable electronic communication device being unable to receive DVB-H data bursts. By extracting channel data from the DVB-H data bursts and sending the channel data using a technology different from the DVB-H technology, the at least one other portable electronic communication device can receive channel A data without being equipped with a DVB-H receiver.

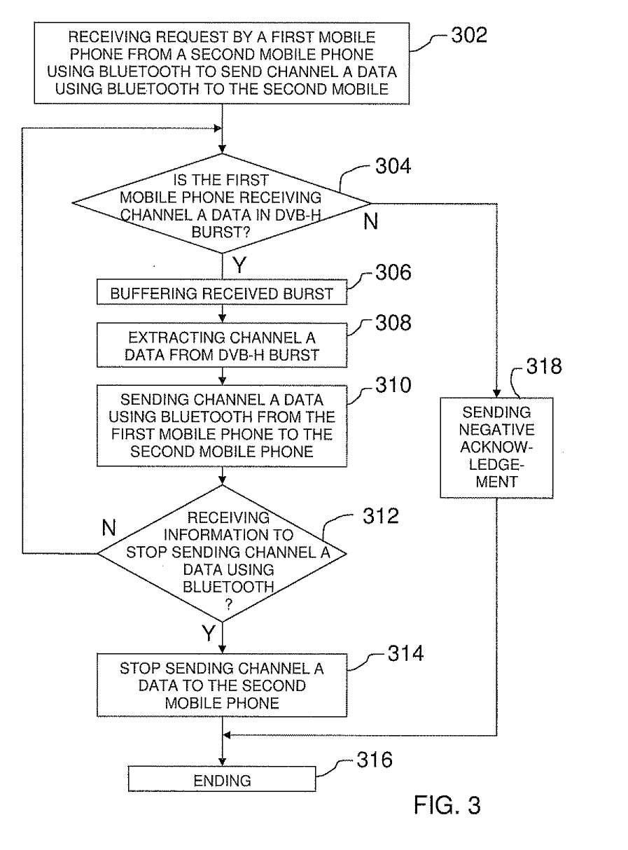

By referring to FIGS. 1 and 3, schematically showing a portable electronic communication device according to an alternative embodiment of the invention, and presenting a flow chart of an exemplary method of providing a first media data, according to one embodiment of the invention, by a first portable electronic communication device 100, respectively, an alternative embodiment of the invention is explained in more detail.

Processing may begin with a first portable electronic communication device (e.g., a mobile phone) receiving a request for first media data from a second portable electronic communication device (e.g., a mobile phone) via a second communication technology (e.g., using Bluetooth) to send channel A data to the second mobile phone (block 302). Other communication technologies may be used as the second communication technology. This request may be received by second receiving unit 102 under the control of the control unit 112, as previously described in connection to FIG. 2. Having received the request in block 302, it may be determined whether or not the first mobile phone, as one example of a portable electronic communication device, is receiving channel A data in DVB-H data bursts (block 304). The determining may be performed by the control unit 112 in dependence of potential DVB-H data that may be received by the first receiving unit 104. If the control unit 112 determines that the first mobile phone is receiving channel A data in DVB-H bursts, the received data, as received in the burst, may be buffered in the memory unit 106 (block 306). After having buffered the received data comprising channel A data in the memory unit 106, channel A data from the DVB-H data burst may be extracted (block 308) by the data extracting unit 108 under the control of the control unit 112.

According to one embodiment of the invention, the channel A data may be available in the form of Internet Protocol (IP) datagrams which can be sent, for example, using Bluetooth, from the first mobile phone to the second mobile phone (block 310). The transmitting may be performed by the transmitting unit 110, possibly having access to the IP datagrams from the extracting unit 108, under control of the control unit 112.

As mentioned above, in this exemplary method, the first mobile phone provides channel A data to a second mobile phone which is unable to receive channel A data bursts. For this reason and for the reason that a potential user of the second mobile phone may want to consume presented channel A data longer than the duration of channel A corresponding to one DVB-H data burst, which consumption duration is about 4 seconds, sending one single DVB-H data burst will typically not suffice. There is thus a need to provide an opportunity for the first mobile phone to continue providing channel A data to the second mobile phone after having sent channel A data corresponding to one data burst. Moreover, the method may also provide an opportunity to stop sending channel A data in case channel A data is to be sent for longer durations than the one corresponding to one DVB-H data burst.

The first mobile phone may determine whether or not the first mobile phone is receiving information to stop sending channel A data to the second mobile phone (block 312). In case the first mobile phone is not receiving such information, processing may return to block 304 with the first mobile phone determining whether or not the first mobile phone is receiving channel A in DVB-H data bursts.

In this way, new channel A DVB-H data bursts can be received, and data there from extracted and sent by the first mobile phone to the second mobile phone being unable to receive the DVB-H data bursts.

If the control unit 112 determines that the first mobile phone does receive information to stop sending channel A data using, for example, Bluetooth, the first mobile phone may stop sending channel A data to the second mobile phone (block 314). The first mobile phone may perform this act using the control unit 112 in dependence on potential information received by the second receiving unit 102.

If, however, it is determined that the first mobile phone is not receiving channel A data, the first mobile phone may send a negative acknowledgement to the second mobile phone (block 318). Within this embodiment, the acknowledgement may be sent using the same communication technology as was used when receiving the request in block 302. In this example, Bluetooth technology may be used. Again, this technology is just one example of a variety of other communication technologies that may be used.

After having stopped sending channel A data using Bluetooth from the first mobile phone to the second mobile phone in block 314 or alternatively after having sent the negative acknowledgement in block 318, the method may end (block 316).

According to an alternative embodiment, the first communication technology may comprise Integrated Services Digital Broadcasting-Terrestrial (ISDB-T).

According to yet another embodiment of the invention, the first communication technology may comprise Digital Multimedia Broadcasting (DMB).

FIG. 4 displays a portable electronic communication device 40 in the form of a mobile phone, according to one embodiment of the invention.

In addition, FIG. 5 schematically depicts a computer program product 50 according to one embodiment of the invention, having thereon computer program code. When the computer program code, included on the computer program product, is loaded in a computer or portable electronic communication device, the computer or portable electronic communication device may receive a request from a second portable communication device to send first media data to the second portable communication device, receive the first media data in the form of bursts using a first communication technology, and send the first media data to at least the second portable communication device using a second communication technology, such that the second portable communication device can receive the first media data using the second communication technology.

The computer program product may be provided as a CD-ROM disc according to one embodiment of the invention. However, the computer program product 50 can alternatively be provided as another type of disc such as a DVD disc, a hard disc, or be provided as a memory or other storage capacity, such as a flash-based memory, for example a memory stick or a USB (Universal Serial Bus) memory or even a volatile memory.

The computer may be implemented as a microcontroller, which is well known to a person skilled in the art.

Embodiments of the invention also include a computer program element having program code. When computer program code is loaded in a computer or portable electronic communication device, the computer or portable electronic communication device may receive a request from a second portable communication device to send first media data to the second portable communication device, receive the first media data in the form of bursts using a first communication technology, and send the first media data to at least the second portable communication device using a second communication technology, such that the second portable communication device can receive the first media data using the second communication technology.

This computer program element or parts thereof may be accessible for downloading over the Internet or by using Wireless Application Protocoll (WAP) or by other techniques for downloading. According to an alternative embodiment of the invention, this computer program element may be accessible via the DVB-H network.

Embodiments consistent with principles of the invention significantly reduce the waiting time until requested media data can be presented to a portable electronic communication device without decreasing the bandwidth available for media data.

Embodiments consistent with principles of the invention also provide an opportunity to receive broadcast transmissions by a portable electronic communication device over a non-broadcast communication channel.

It should be emphasized that the term “comprises/comprising” when used in this specification is taken to specify the presence of stated features, integers or steps, but does not preclude the presence or addition of one or more other features or steps.

It is emphasized that this invention can be implemented in many ways, of which the alternative embodiments above only are examples of a few. These different embodiments are hence non-limiting examples.

According to another embodiment of the invention, the portable electronic communication device may include a different set of units for which the functions may be different, for which reason various different connections connecting the units may be envisaged. Units may be combined, divided or separated in a variety of ways.

According to yet another embodiment, buffering the received burst data may be omitted since extracting channel A information may be performed on the received data burst itself.

Moreover, according to still yet another embodiment, extracting media data, by the extracting unit 108 may be omitted since the media data of the burst, may be directly accessible by the transmitting unit 110.

According to still yet another embodiment of the invention, extracting media data from the DVB-H burst may include extracting MPEG-2 data.

While the above description focused on providing media data from a first portable communication device to a second portable communication device, implementations, consistent with principles of the invention are not so limited. For example, in some embodiments of the invention, the first portable communication device may broadcast the media data to a group of second portable communication devices.

While series of acts have been described with respect to FIGS. 2 and 3, the order of the acts may be varied in other implementations consistent with the invention. Moreover, non-dependent acts may be implemented in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects of the invention were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit, a field programmable gate array, a processor, or a microprocessor, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. Method of providing a first media data by a first portable electronic communication device, comprising:
receiving a request from a second portable communication device to send first media data to the second portable communication device,
receiving the first media data in the form of bursts using a first communication technology,
sending the first media data to at least the second portable communication device using a second communication technology, the second communication technology being different than the first communication technology,
such that the second portable communication device can receive said first media data using the second communication technology.

2. Method of providing first media data according to claim 1, wherein the first communication technology comprises a digital video broadcasting-handheld (DVB-H) broadcasting communication technology.

3. Method of providing first media data according to claim 1, further comprising:
extracting the first media data from at least one of the received bursts.

4. Method of providing first media data according to claim 1, wherein the second communication technology comprises a wired communication technology.

5. Method of providing first media data according to claim 1, wherein the receiving the request comprises:
receiving the request using a third communication technology.

6. Method of providing first media data according to claim 5, wherein the third communication technology comprises the second communication technology.

7. Method of providing first media data according to claim 1, wherein the second communication technology comprises a wireless communication technology.

8. Method of providing first media data according to claim 7, wherein the second communication technology comprises Bluetooth technology.

9. Method of providing first media data according to claim 7, wherein the second communication technology comprises infra-red communication technology.

10. Method of providing first media data according to claim 7, wherein the second communication technology comprises communication over a wireless local area network.

11. Portable communication device comprising:
a first receiving unit arranged to receive first media data in the form of bursts using a first communication technology,
a second receiving unit arranged to receive a request from a second portable communication device to send first media data to the second portable communication device,
a transmitting unit arranged to send the first media data to at least the second portable communication device using a second communication technology, the second communication technology being different than the first communication technology, and
a control unit arranged to control receiving the first media data in the form of bursts using the first communication technology, to control receiving the request from the second portable communication device to send first media data to the second portable communication device, and to control sending the first media data to at least the second portable communication device using the second communication technology,
so that first media data is provided to the second portable communication device.

12. Portable electronic communication device according to claim 11, wherein the first receiving unit comprises a digital video broadcasting-handheld (DVB-H) receiver arranged to receive broadcasted media data.

13. Portable communication device according to claim 11, further comprising a data extracting unit arranged to extract the first media data from at least one of the received bursts.

14. Portable communication device according to claim 11, wherein the transmitting unit comprises a Bluetooth transmitter, wherein the control unit further is arranged to control sending the first media data to at least the second portable communication device using Bluetooth technology.

15. Portable communication device according to claim 11, wherein the second receiving unit comprises a Bluetooth receiver.

16. Portable communication device according to claim 11, wherein the portable communication device and the second portable communication device include mobile phones.

17. Computer program product comprising a computer readable medium having thereon computer readable code, to make a computer or a portable electronic communication device execute, when said computer readable code is loaded in the computer or the portable electronic communication device, a method comprising:
receiving a request from a second portable electronic communication device to send first media data to the second portable electronic communication device,
receiving the first media data in the form of bursts using a first communication technology, and
sending the first media data to at least the second portable electronic communication device using a second communication technology, the second communication technology being different than the first communication technology.

18. Computer program element comprising computer readable code to make a computer or a portable electronic communication device execute, when said computer readable code is loaded in the computer or the portable electronic communication device, a method comprising:
receiving a request from a second portable communication device to send first media data to the second portable communication device,
receiving the first media data in the form of bursts using a first communication technology, and
sending the first media data to at least the second portable communication device using a second communication technology, the second communication technology being different than the first communication technology.
